(19) United States
(12) Patent Application Publication
(10) Pub. No.: US 2014/0326195 A1
(43) Pub. Date: Nov. 6, 2014

(54) Apparatus For Repelling Pests

(71) Applicant: William Gitrie, West Bloomfield, MI (US)

(72) Inventor: William Gitrie, West Bloomfield, MI (US)

(21) Appl. No.: 14/266,985

(22) Filed: May 1, 2014

Related U.S. Application Data
(60) Provisional application No. 61/818,591, filed on May 2, 2013.

(51) Int. Cl. A01M 29/10; A01M 29/30; A01M 29/00

(52) U.S. Cl. CPC A01M 29/10; A01M 29/00; A01M 29/30
USPC 119/712

(57) ABSTRACT

A pest repelling apparatus including pest detectors which normally activate a repelling device but which are arranged to prevent activation of a repelling device when a human is detected. A delayed water spray acting as a repelling device may be activated after a sound or light emitting source has been activated. A series of repelling apparatuses may be connected together either by a wired or wirelessly connection to operate an irrigation sprinkler system when a pest is detected.

### CROSS REFERENCE TO RELATED APPLICATIONS

This application claims the benefit of U.S. provisional patent application No. 61/818,591 filed on May 2, 2013.

### BACKGROUND OF THE INVENTION

This invention concerns apparatus for repelling pests such as birds and small animals intruding into selected areas, such as lawns, decks, etc.

Various devices have been developed intended to accomplish this end.

Typically, detectors are arranged to monitor the area and if an intruding pest is detected, a signal from the detector activates a repelling device, causing the pest to withdraw from the area monitored. The detectors typically direct a sonic waves or electromagnetic radiation into the area, which reflect from the intruder and return to the detector. Or, an infrared sensor can detect the warmth radiating from the body of the pest.

Detection of return waves activates the repelling device which generates a repelling disturbance in the vicinity, such as by directing a water spray into the monitored area, broad casting sounds, or energizing bright lights, lasers, etc so as to cause pest to exit from the area.

While generally effective, some common problems are encountered in the operation of such devices.

If the detectors do not discriminate pests from humans moving into the area, this will trigger the device for repelling the pest and the person may be annoyingly subjected to the effects of the activating the repelling device.

False positive of the sensors also occurs due to unreliability of detecting the intrusion of a pest.

Another problem is encountered if a water spray is used as a repellant, and water from a reservoir is used to create the spray, as the water supply in the reservoir may be quickly depleted, necessitating frequent refills.

A related problem is the tendency of certain birds to build nests in covered areas, such as beneath docks and boat canopies, which are quickly rebuilt by the birds if they are simply removed.

Accordingly, it is an object of the present invention to provide such a pest repelling apparatus which will improve the reliability of detecting an intruding pest and will minimize the possibilities of triggering operation of a repelling device by a person entering the protected area.

It is another object of the invention to provide a repelling device using a water spray which alleviates the problem of too rapid emptying of a water reservoir which supplies the sprayer.

It is a further object to provide a repelling device which can be particularly adapted to monitor areas of various configurations.

### SUMMARY OF THE INVENTION

The above objects of the present invention as well as other objects which will be understood upon a reading of the following specification and claims are achieved by an apparatus including an arrangement of a plurality of detectors, or sets of detectors, with signals from the detectors being responded to by a control so as to not activate the repelling device when a person enters the monitored area.

These detectors can be variously angled and may be different in number with an associated corresponding detection algorithm determining when activation of the repelling device should occur.

In a first embodiment, a first detector of the detector arrangement detects intrusions in a space at a low level above a monitored area. A second detector of the arrangement detects intrusions in a space higher above a monitored area corresponding to the height of a person's upper torso. Even after detection of an intrusion into the lower space above the monitored area by the first detector, the repelling device will not necessarily be activated but such activation will also require that the high level detector does not detect an intrusion into the space above the lower space.

Upon activation, the repelling device causes a disturbance in the vicinity of the monitored area of a nature which causes typical pests to exit the area, i.e. energizes a light, initiates a vibration, generates a water spray, or broad casts a sound likely to disturb a pest, etc.

In a second embodiment another arrangement of two detectors (or sets of detectors) is employed to monitor spaces above first and second respective monitored areas.

A first detector (or group of detectors) is of an infrared type which detects the warmth emanating from a warm bodied pest such as a bird or small animal intruding into the space above a first monitored area. Again, this detection will not in itself result in activation of the repelling device if a second detector (or group of detectors) also detects movement within a second space defined above a second area offset from the first area. Activation of the repelling device will only occur if there is an absence of a detected intruder in the second space.

This allows free movement of humans through the second space without activation of the repelling device.

The first and second detectors can both be of an ultrasonic type, which emit high frequency sound waves into the space of the first and second monitored areas, and detects any return reflections from impinging an intruder.

This arrangement of detectors thus defines a desired monitored area which area can vary in configuration and size depending on the location and range of the detectors or set of detectors, such as two nested rectangular areas.

Furthermore, multiple sets of combined detectors can be interconnected by wire or wireles sly, and deployed to create narrow target areas extending along the shore of a pond, lake or stream or over the pond itself for a substantial distance.

Thus, a person can freely walk back and forth through areas close to the front of the detectors without triggering the repelling device.

The apparatus may advantageously be combined with existing equipment such as an irrigation sprinkling system or flood lights which can be turned on to perform as a repelling device instead of relying on a water spray which relies on a refillable reservoir for its water supply.

A compact version of the apparatus can be secured beneath a dock, boat, canopy or other covered area to deter nesting of birds there.

The arrangement of detectors can be installed in an upright tubular housing or alternatively can be built into existing structures such as walls, boat hulls, etc.

A rain collector dish can be associated with a reservoir in an upright housing which supplies a water spray to reduce the frequency of refillings thereof.

A water spray repelling device can be advantageously combined with a sound, vibrator, or light emitter in such a way that the water spray is activated only after a predetermined delay after the time that the sound or light is initially energized, and is not activated if the pests are not detected in the area during the delay period. Over time, the pests may be conditioned to leave the area solely by activation of the sound broadcast or bright light display alone by a Pavlovian association to create a conditioned response to the generation of the sound, vibration, light or other device and the subsequent activation of the water spray if the pest persists.

A particular light generating device can be used in which a mirrored ball is rotated while a number of lights are shone on the ball. The axis of rotation of the mirrored ball may be skewed to cause mutation of the ball to create random light display patterns which are believed to greatly alarm waterfowl and small animals.

### DESCRIPTION OF THE DRAWINGS

FIG. 1 is a diagram of a repelling apparatus according to the invention with an outline of a human and a waterfowl intruding into the space above a monitored area.

FIG. 1A is a block diagram depiction of the components of the repelling apparatus shown in FIG. 1.

FIG. 2 is a pictorial view of a mobile version of the apparatus according to the present invention.

FIG. 2A is an enlarged fragmentary view of the bottom of a modified form of the apparatus depicting a rain collector dish.

FIG. 3 is a diagram of a built-in form of the apparatus showing a defined targeting area established thereby.

FIG. 4 is a diagram of a number of apparatuses connected together and arrayed along the shore of a body of water and connected to an associated conventional sprinkler irrigation system.

FIG. 5 is a pictorial view of the underside of a dock having a compact version of the apparatus installed thereon.

FIG. 5A is an enlarged pictorial view of the apparatus shown in FIG. 5.

FIG. 6 is a pictorial fragmentary pictorial view of the stern of a boat having a built in repelling apparatus according to the present invention installed therein.

FIG. 7 is a partial sectional view of a randomly varying light source used as a repelling device.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

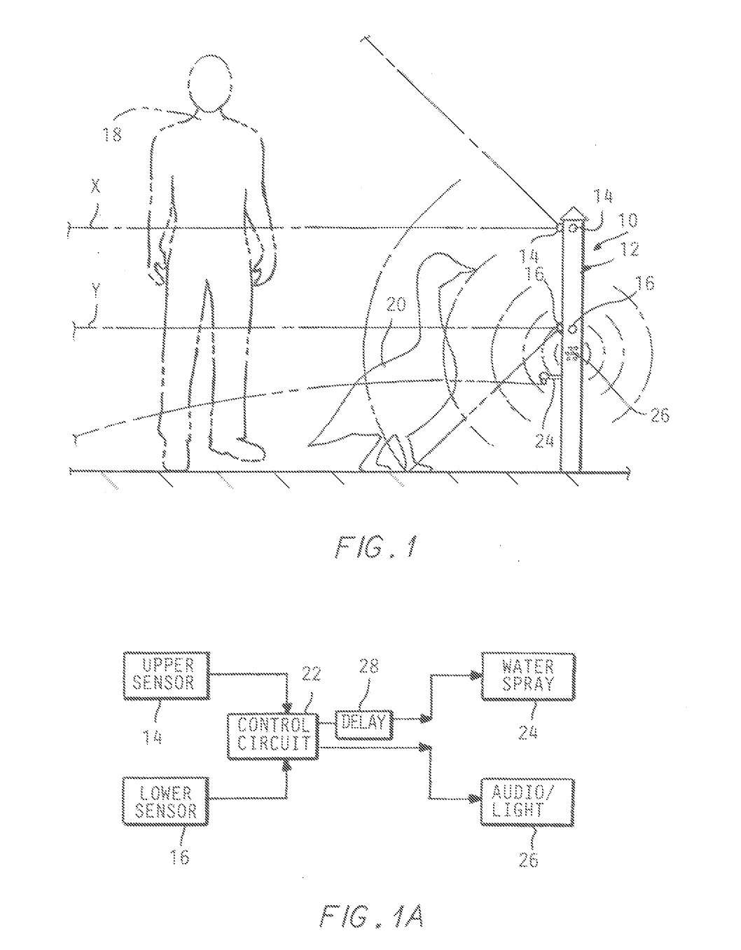

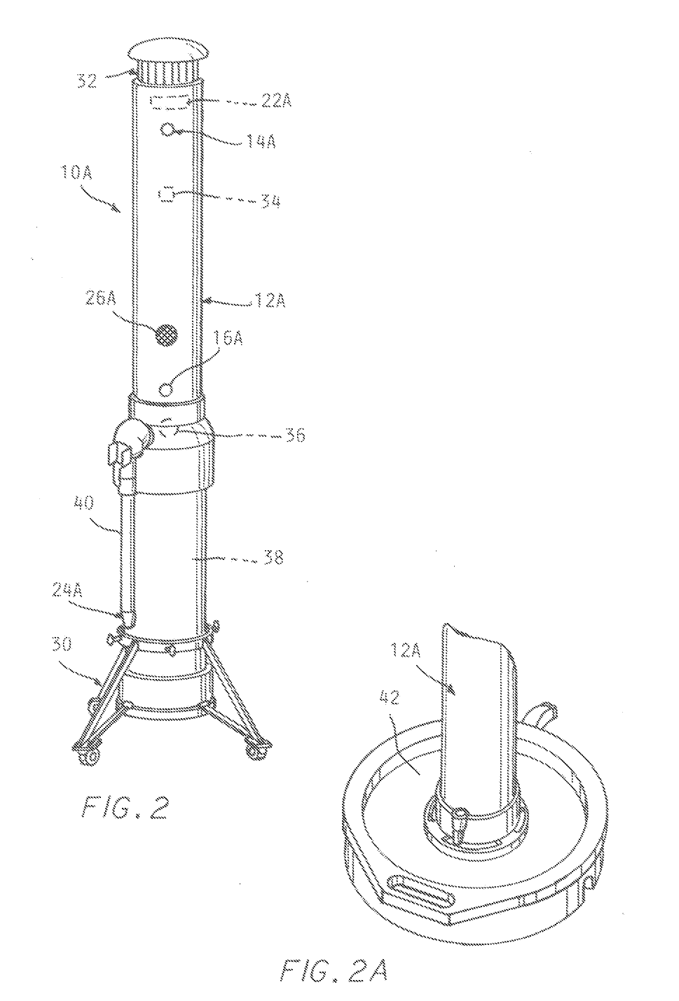

Referring to the drawings and particularly FIG. 1, a repelling apparatus 10 according to the invention, is shown, which can include an upright housing 12 which can be buried at its lower end or held in a base (as shown in FIG. 2) extending vertically up from on the ground.

An arrangement of two detectors 14, 16 is mounted on one or more sides of the housing 12, vertically spaced apart.

The detectors 14, 16 detect the intrusion of a pest into a respective one of a first or second space above a monitored area adjacent the housing 12, as by broadcasting ultrasonic waves into those spaces and detecting any waves reflected back to the respective detector 14 or 16. The detectors 14, 16 in each arrangement include an upper detector 14 and a lower detector 16 from which emanate waves at respective levels X and Y. Thus, detector 14 does not receive any reflected waves from a body located below level X, while detector 16 does not receive any reflected waves from a body located above level Y.

Thus, if the body of a pest 18 or 20 intrudes into the space opposite lower detector 16, this triggers a signal corresponding to the presence of the body 18 or 20 regardless of its height. A control circuit or programmable controller 22 receives that signal.

A higher detector 14 will detect the presence of a taller body 18, and a signal sent to the controller 22. A repelling device is activated by the control 22 to create a disturbance in the monitored area of a nature which will cause pest to leave the monitored area when the proper combination of signals from the detectors 14, 16 occurs. The repelling device can be a combination of a water spray 26 or a loud speaker 26.

That is, the controller 22 does not activate cause a disturbance to be generated in the monitored area solely in response to the signal from the lower detector 16.

That is, only if there is a detection of the presence of a body 18, 20 only by the lower detector 16 and no intrusion into the upper space detected by detector 14 does the controller 22 activate the water spray 24 audio speaker 26 to broadcast a repelling noise.

A circuit delay 28 may temporarily prevent activation of the water spray 24 for a few seconds.

If the lower detector 16 continues to detect a body 18, 20 in the lower space above the area for those few seconds notwithstanding the noise generated, the controller 22 then also activates the water spray 24.

This delayed activation reduces the volume of water used to conserve the water in a reservoir if such stored water is used to supply a pump used to create the water spray 24. Thus, if the presence of a person is causing the lower detector 16 to detect his or her presence, the upper detector 14 will generate a signal transmitted to the controller 22 which results in the controller 22 not activating either the water spray 24 or the speaker 26.

The use of the two detectors 14, 16 improves the detection process and minimizes false hits.

FIG. 2 shows a mobile repelling apparatus 10A including an upright housing 12A supported upright on a wheeled holder 30.

The controller 22A is located within the housing 10A beneath a solar charger 32 used to charge a battery 34 powering the controller 22A and a solenoid/pump assembly 36 mounted above a water reservoir 28 in the housing 12A.

Water is pumped into a vertically descending hose 40 having a spray jet 24A at the bottom.

FIG. 2A shows a rain collector dish 42 extending around the housing 12A designed to catch rainwater and collect the same in reservoir 30 so as to reduce the frequency of adding water to keep some water in the reservoir 38 available so as to enable a water spray to be more reliably created.

Referring to FIG. 3, arrangements of sets of two different types of detectors 44, 46, are shown, installed in respective building walls 48, 50 extending at right angles to each other.

First detectors 44 maybe infrared detectors of a type able to detect an intruding warm blooded pest and generate a corresponding output signal.

Second detectors 46 are of a type designed to detect the intrusion of the body of a pest, such as ultrasonic detectors which broadcast high frequency sound waves into spaces above a monitored area and detect any return reflected waves and corresponding signals are generated.

Both of these detector signals are transmitted to the controller 22 (not shown in FIG. 3). If a warm body is detected by the detectors 44, the resultant output signal is sent to the controller 22, but no activation of a repelling water spray from a spray jet 50 results from the receipt of that signal alone. Rather, only if the detectors 46 produce a signal corresponding to an intruding body being a predetermined distance from the detectors 46 will the controller 22 activate the water jet spray 50 or other repelling device.

Two sets of detectors 44, 46 arranged 90° from each other can thus define a rectangular monitored area 52 as shown in FIG. 3.

Accordingly, a person standing or walking alongside the walls 48 would not cause activation of a repelling device, i.e. the spray jets 50.

A light or sound type repelling device could be combined with the water spray with a delayed activation of the water supply as described above.

A monitored area 52 of any shape or size can be defined by properly locating and orienting the detectors 44, 46 which will cause activation of one or more repelling device.

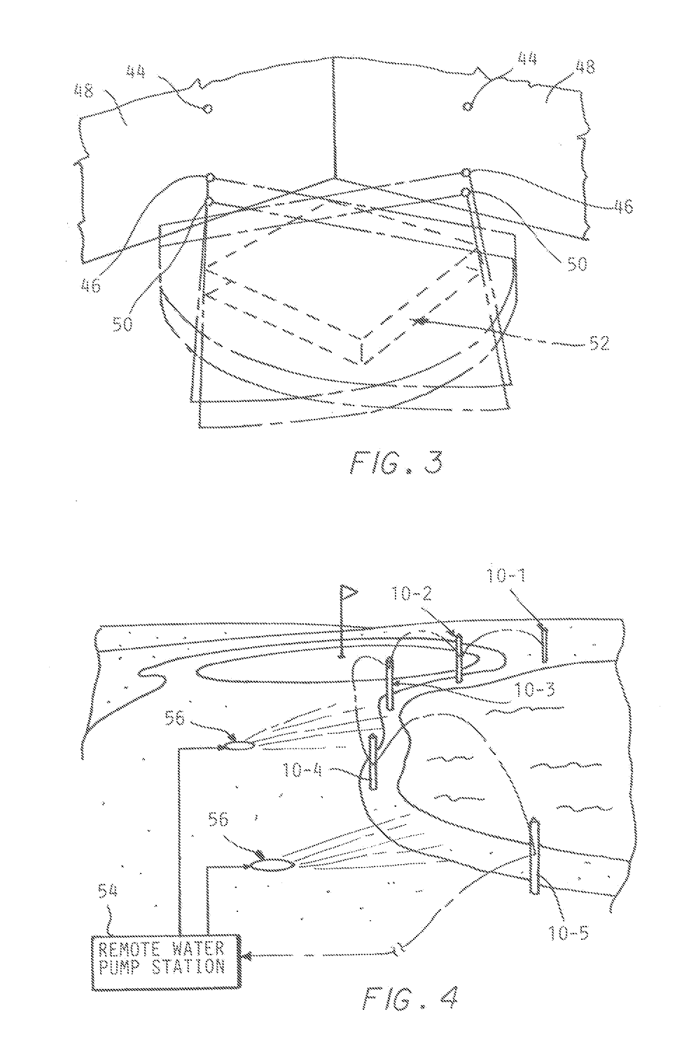

FIG. 4 shows a series of repelling apparatuses 10-1 to 10-5 arranged along a shoreline of a body of water connected together by wiring or by wireless connection.

These are connected to a control station 54 which activates irrigation sprinklers 56 so that if a pest is detected by the detectors of any one of the repelling apparatuses 10-1 to 10-5, a part of the entire sprinkler system adjacent that particular apparatus is turned on. Alternatively, the entire sprinkler system can be turned on to simplify the control 22.

Thus no water reservoir or separate pump is necessary to repel pests in the area along the shoreline.

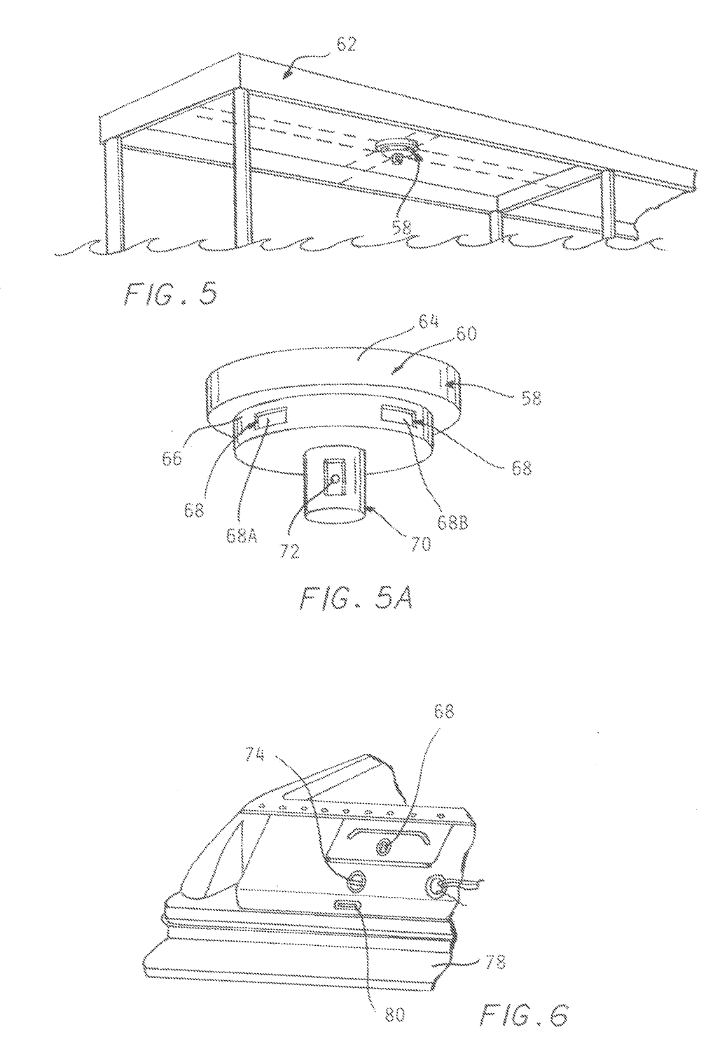

Referring to FIGS. 5 and 5A, a compact version of a pest repelling apparatus 58 is shown, comprised of a short stepped cylinder body 60 adapted to be mounted to an overhead surface such as beneath a dock 62 (or a pontoon boat canopy) to deter nesting under the dock 62 or canopy by any bird species prone to do so.

A base section 64 houses a circuit board and batteries.

Detector sets 68 are housed in a second section 66, each detector set 68 including circumferentially spaced pairs of detectors 68A, 68B shown with an additional pair on the backside thereof (not visible) such as the ultrasonic detectors described above. The detector ranges may be adjusted by rotation of the second section 66 when mounting the same.

A plurality of water spray jets 72 are provided in a downwardly projecting tube 70, supplied by a battery powered pump (not shown).

The detectors 68A, 68B and other detectors not shown will detect anything intruding into the space beneath the dock 62 and immediately causes a water spray to be generated in directions extending along the under surface of the dock 62.

As noted above in connection with FIG. 4, the components can be built into a structure.

FIG. 6 shows a pair of vertically spaced sensors 74, 76 and a sprayer slot 72 disposed in the stern of a boat, protecting a swim platform 78 from any roosting birds. A battery operated pump (not shown) creates a water jet spray emanating from slot 80 when intrusion of a pest is detected as described above.

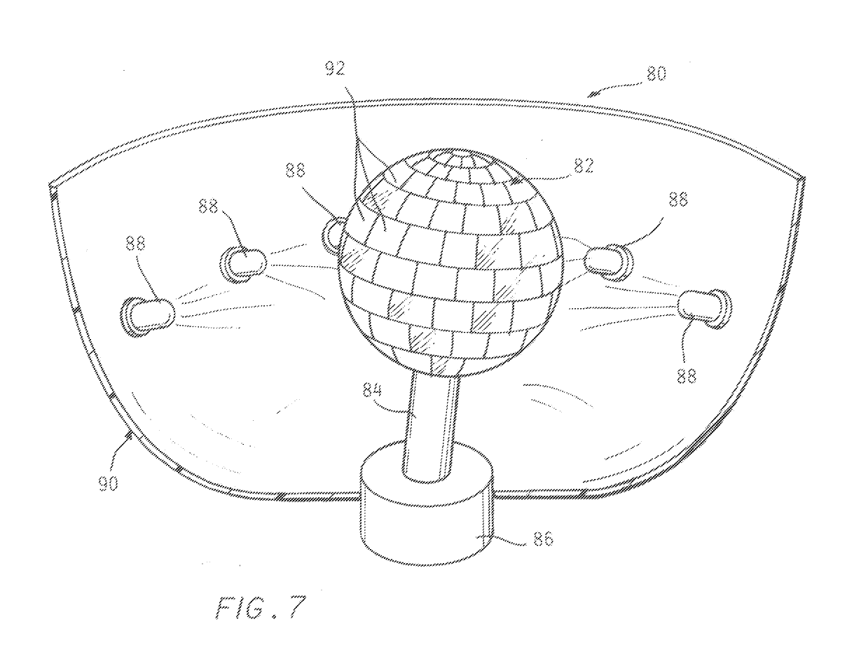

Referring to FIG. 7, a light source repelling device is depicted and comprises a small “disco” mirrored ball 82 mounted on slightly inclined shaft 84 rotated by a small motor 86.

A series of LED lights 88 (which may e of different colors) are mounted extend around the circumference of a transparent support dish 90.

The reflections from the small minors 92 on the mirrored ball 82 of light from the LED's 88 as the ball rotates and nutates (wobbles) due to the inclined axes of the shaft 84.

This is believed to greatly disturb pests, particularly water fowl, such that they will quickly exit the area. The unusual nature of the light produced and stimulation of the fear of waterfowl in thinking it is being viewed by a predator is believed to create a strong response by waterfowl to cause them to quickly exit the area of the light repelling device 80.

1. An apparatus for repelling pests from a monitored area comprising:
a repelling device which when activated generates a disturbance in said monitored area acting to repel pests entering into said monitored area; and
a detector arrangement detecting when any pest intrudes into spaces adjacent said detector and above said monitored area, and a control activating said repelling device when a pest is detected intruding into said space adjacent said detector arrangement;
said detector arrangement including a combination of detectors including a first detector which detects when a pest intrudes into a first space above said monitored area and a second detector which detects when a human intrudes into a second space above said monitored area; and
said control activating said repelling device only when said first detector detects the intrusion of said pest into said first space above said monitored area and only when said second detector does not detect the intrusion of a human into said second space above said monitored area.

2. The apparatus according to claim 1 wherein said first detector comprises an infrared detector detecting heat emanating from a warm blooded pest intruding into said first space.

3. The apparatus of claim 2 wherein said second detector comprises a detector detecting the presence of a human intruding into said second space, said second space being located laterally offset from said first space, whereby activation of said repelling device is not activated if a human does not intrude into said second space.

4. The apparatus according to claim 1 wherein said first detector directs wave energy into said adjacent space and receives any reflection back thereof from said pest indicating the intrusion of a pest into said first space, and said second detector directs wave energy into said second space to a human intruding into said second space and said second space is located above said first space and over said monitored area, whereby the detection of a human being prevents the activation of said repelling device by said control.

5. The apparatus according to claim 1 wherein said repelling device comprises the combination of a water sprayer and a sound or light emitter and wherein said control initially activates said sound or light emitter and subsequently said water sprayer after only a predetermined delay and only if the intrusion of a pest is still detected by said first detector whereby usage of said water sprayer is minimized.

6. The apparatus according to claim 1 wherein said detectors are mounted to an upright housing at vertically spaced locations thereon.

7. The apparatus according to claim 6 wherein said housing is mounted to wheeled support.

8. The apparatus according to claim 1 wherein said repelling device comprises an irrigation system including a plurality of sprinklers.

9. The apparatus according to claim 8 further including a series of apparatuses according to claim 1 connected together in said series to said irrigation system to be activated by any apparatus in said series.

10. The apparatus according to claim 1 wherein a plurality of detector arrangements are located and spaced to create a central area monitored by said first detector and laterally offset areas adjacent thereto monitored by said second detector.

11. The apparatus according to claim 1 wherein said repelling device includes a light comprising a mirror ball mounted to one end of a shaft rotated by a motor with a series of lights supported extending around said mirrored ball to cause varying reflections from said ball as it is rotated.

12. The apparatus of claim 11 wherein said shaft is skewed so as to cause a motion as said mirrored ball is rotated.
